(19) United States
(12) Patent Application Publication
(10) Pub. No.: US 2011/0278096 A1
(43) Pub. Date: Nov. 17, 2011

(54) Passenger Lift System with Access Control

(76) Inventors: Walter Kentenich, Troisdorf (DE); Christian Lucaci, Ruppichteroth (DE)

(21) Appl. No.: 13/086,818

(22) Filed: Apr. 14, 2011

(30) Foreign Application Priority Data
Apr. 15, 2010 (EP) 10 160 074.0

(51) Int. Cl. B66B 9/00; B66B 9/08

(52) U.S. Cl. 187/201; 187/200

(57) ABSTRACT

A passenger lift system has a passenger supporting unit, a drive for the passenger supporting unit, an access control associated with the drive and in particular connected upstream, in or downstream to it and further including a radio field generator generating a spatially activity-limited stray field around the passenger supporting unit, a radio controller capable of being introduced into the stray field, and an activator switching the access control in response to effective introduction of the controller into the stray field, in particular switching it ready for driving. Further, the lift system includes an access authorization control system regulating the authorization for use of at least one such passenger lift system wherein one or more radio controllers is associated with one or more passenger lift systems for switching the access control.

### CROSS-REFERENCE TO RELATED APPLICATIONS

This application is a Paris Convention Filing under 35 U.S.C. § 119 and claims priority to and benefit from European Patent Application EP 10 160 074.0, filed on Apr. 15, 2010.

### BACKGROUND OF THE INVENTION

The present invention relates to a passenger lift system protected from unauthorized use by access control. Generally and according to the prior art, such passenger lift systems have a passenger supporting unit and a drive for this passenger supporting unit, wherein an access control is associated with the drive, in particular connected upstream, in or downstream to it.

An example for such a passenger lift system is a stair lift. Conventional stair lifts often have a lock as the access control, which prevents the operation of the element controlling the passage (for example a joystick) of the stair lift in the locked state. Authorized persons can unlock the lock with a key and then use and operate the stair lift.

Disadvantageously, especially persons, who are dependent on the aid of passenger lift systems, are also often faced with difficulties when they are to unlock such locks. Thereby, the access approval is complicated, and in some cases, especially if elder people or disabled people have difficulties in inserting the key into the lock, the use can become nearly or completely impossible.

### BRIEF SUMMARY OF THE INVENTION

The present invention has set itself to further develop a passenger lift system such that the disadvantages of the prior art are overcome. In particular, an uncomplicated access to the unblocking of a passenger lift system provided with access control is to be allowed.

According to the invention, this object is solved by a passenger lift system according to claim 1. The dependent claims define preferred embodiments of the invention.

The passenger lift system according to the invention has a radio field generator generating a spatially activity-limited stray field in the region of the passenger supporting unit, a radio controller capable of being introduced into the stray field, and an activator, which switches the access control, in particular switches it ready for driving, in response to effective introduction of the controller into the stray field.

In other words, the present invention provides an access control or access authorization control based on a radio system for a passenger lift, which operates in contactless manner and telecontrols the activator for switching the access control. It could also be said that the invention provides an approach activation for a passenger lift system, which in particular does no longer require mechanical operation.

In particular, the advantage is in that also people with movement disabilities or motor disabilities, for whom such passenger lift systems are often specially provided, readily overcome the access control of such a lift system, thus are able to activate the lift system for use. Therein, they do not have to do anything other than to carry the radio controller with them, since they can automatically effect the activation of the drive or of the access control upon approach to the passenger lift system or to the activator and the radio field generator. Thus, a person with access authorization simply has to move in or on the passenger supporting unit and immediately can begin the transport, while unauthorized persons cannot make use of the passenger lift system. This all occurs in completely automated manner and without particular requirements to the handling capabilities of the user.

A passenger lift system according to the present invention can be one of the following systems:

a stair lift system with a seat or chair as passenger supporting unit and a running rail drive associated with the seat or chair,

a platform lift system with an accessible or passable platform,

a ramp lift system

a cabin lift system.

The above list indicates examples for systems according to the invention, but is not exhaustive. Thus, for example, it is not necessarily required that a height difference is overcome by the passenger lift system according to the present invention, rather the transport of the persons can also occur in a large part or merely horizontally. In many cases, the employment of passenger lift systems according to the invention should be profitable in particular for physically disabled people, which of course particularly has a beneficial effect if such persons are aided in overcoming height differences. However, horizontal arrangements such as transport belts are basically also within the general scope of the present invention, the field of application of which can also be characterized in that the passenger transport always is effected on the same path, thus on a preset, determined transport route. Therefore, a passenger lift system according to the present invention is also classified such that it is stationary or fixedly installed in its overall assembly and only allows transport within this overall assembly, in particular a short-distance transport (over paths of e.g. about 1 m-15 m, in longer lift systems or belts also up to 100 m or in this order of magnitude).

The drive of a passenger lift system according to the invention can be a manual drive (e.g. a crank drive) or a power-assisted drive, in particular an electric, a mechanic, a hydraulic or a pneumatic drive or a mixed form of these drives. Therein, it is possible that drive elements disposed on the passenger supporting unit are configured as a passive or active drive element. An example for a passive drive element would be a claw on a passenger supporting means, which is able to latch in or engage with an externally driven conveyor chain or conveyor belt. An example for an active drive element would be a motor attached to the passenger supporting unit with a propulsion element, for example a drive roll and possibly an interposed gearing.

In order to switch the access control ready for driving, the activator can directly or indirectly operate a function lock of the passenger lift system, in particular

on the drive itself and/or

on the energy supply of the drive and/or

on an operating element (16) for movement control, e.g. a button or a joystick.

Of course, for example in external drive systems, the entire energy supply can also be switched, thus switched on or switched off. Basically, each switchable element or adjustable element is suitable for the access control, which can make a movement or operation of the passenger lift system possible or impossible.

The radio field generator and the actuator can be a single component or combined in a component. Of course, it is also possible to provide them as a separated unit and to accommodate them in a single or several housings. The collective or adjacent accommodation saves signal paths, while space saving can possibly be achieved or better utilization of free spaces results by separation.

The radio generator field can be a stray field with an effective distance from the activator in the range of 0.25 m to 5 m. Particularly advantageous ranges range from 1 m to 3 m or from 1 m to 2 m. Ranges from 0 to 1 m can also be advantageous. The selection is made according to the case of application and the advantages to be achieved. For example, if one wishes to prevent the activation from already occurring when an authorized person with a transmitter unit is located in a farther environment, the efficacy radius can for example be restricted up to 1 m or up to 2 m. If it is ensured that the user always carries the radio controller on the body and possibly also at the same location (e.g. belt mounting), quite small effective fields can also be realized, for example with a distance from the activator of up to 0.25 m or 0.5 m. Thereby, energy could be saved, which is required in establishing the field.

A passenger lift system according to the invention can be configured such that the radio field generator, the radio controller and/or the activator are configured with radio units, which allow communication or interaction in

an RFID frequency band, and/or

a Bluetooth frequency band, and/or

the kHz frequency band (e.g. 125 kHz), and/or

the MHz frequency band (e.g. 433 or 866 MHz), and/or

the GHz frequency band (e.g. 2.4 GHz).

Basically, of course, all of the available frequency bands effective for such small distances from experience are suitable.

If, as indicated above, an RFID technology is used, the known RFID transponders and field generators can be employed, as they are for example known from anti-theft systems in department stores.

In order to configure the access control is secure manner, it is possible to encrypt the switch signals with a high-security code, in particular with a 128 bit to 1024 bit encryption.

In an embodiment of the present invention, the radio controller has at least one additional switch for remote control or remote triggering of the access authorization control supported by the access control, wherein the additional switch is formed for sending an operating signal by a transmitter on the controller. Thus, a manual and separate activation can still be added to the automatic approach activation, which additionally extends the functional area of the present invention. For example, with such a combination, other persons can effect the activation of the passenger lift system quasi from the outside. Therein, the range of the transmitter on the controller can advantageously be greater than the effective dimension of the stray field, in particular be at least 1.5 times, 2 times or 3 times this dimension, especially be in a range of 3 to 20 m and even up to 100 m (e.g. for transport belts).

According to a design variant of the passenger lift system according to the invention, the switch signals for the access control effect specific, individual access authorizations. For the home use, thus, exactly one radio controller with a trigger protocol can be associated with exactly one field and one activator on the passenger lift.

According to a further aspect of the present invention, it also relates to an access authorization control system regulating the authorization for using at least one passenger lift system, as it has been described above in various embodiments. Therein, one or more radio controllers are associated with one or more passenger lift systems for switching the access control. Thus, the system can include individual passenger lifts or several passenger lifts as well as individual or several controllers.

In an embodiment, the radio controller(s) associated with one or more passenger lift systems are fixedly tuned to the switching of the passenger lift system or the passenger lift systems by factory, in particular with respect to the radio frequency and/or the switch signal identity or encryption. Therefore, a “closed system” is quasi provided here, which, once tuned, associates a certain number of persons with radio controllers exactly with a certain number of passenger lift systems and makes these passenger lift systems accessible for those persons.

In an “open” system, the radio controller(s) associated with one or more passenger lift systems would be programmable or otherwise variably tunable to the switching of the passenger lift system or of the passenger lift systems, in particular with respect to the radio frequency and/or the switch signal identity or encryption. Therein, it is possible to make the radio controllers programmable and tunable to the switching of the passenger lift system or the passenger lift systems by supra-local data transmission, in particular via the Internet. In particular, this has a beneficial effect if an activation in the access authorization is to be effected for a certain category of persons provided with programmable radio controllers, in particular for passenger lift systems in public buildings. For example, persons or groups of persons, which are able to identify themselves as physically disabled at agencies (for example by a security query in the Internet), could download an activation code via the Internet for a certain public building, transmit it to their radio controller through an interface (e.g. USB) and then activate the respective passenger lift systems upon entering the building by approach.

Furthermore, the invention is explained in more detail by way of an embodiment and with reference to the attached drawing. It can include all of the herein recited features individually as well as in any reasonable combination.

### BRIEF DESCRIPTION OF THE DRAWING

FIG. 1, the sole attached drawing, shows a stair lift system fitted with an additional authorization control according to the invention as an embodiment of a passenger lift system according to the invention.

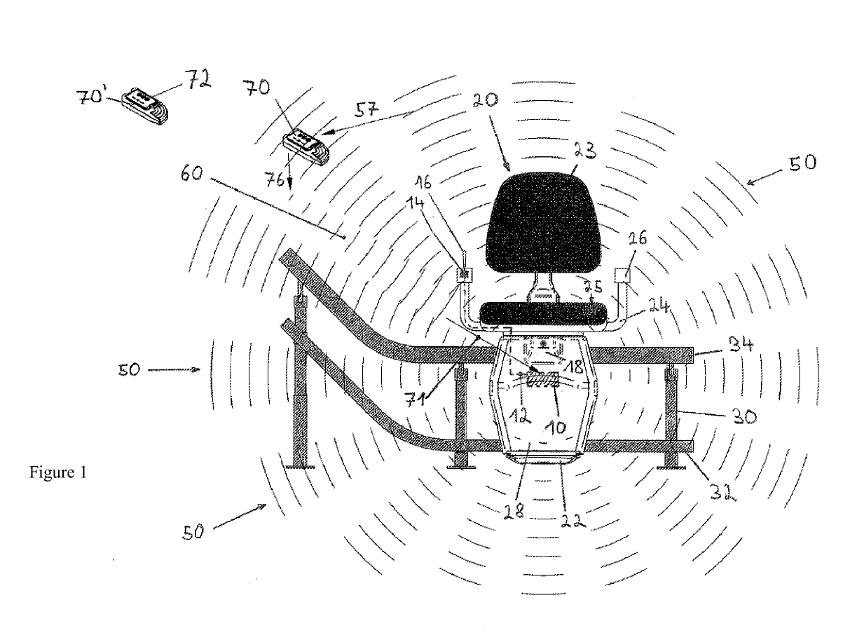

### DETAILED DESCRIPTION OF THE INVENTION

The stair lift system illustrated in the drawing has the chair 20 including a back rest 23, a seating surface 25, a perpendicular plate 28 and a tread 22. Further, two arm rests 24 with arm or hand supports 26 are disposed on the seat.

The chair moves on a rail system with two rails 32 and 34 supported by posts 30; they are mostly attached in the stair boundary region.

In order to move the chair on the running rails 32, 34, a drive is disposed on the chair below the seating surface 25, which is not visible itself in the drawing and only has been indicated in dashed manner at the reference character 18.

In the regular, activated operation, the user seated on the seating surface 25 will be able to operate the drive 18 with the aid of a joystick 16 and thus be capable of moving with the chair 20 on the rails 32, 34. The joystick 16 is attached to one of the hand supports, and its connection to the drive 18 is present, but not separately represented.

However, a switch 14, which can switch on or off the joystick, thus controls the efficacy of the operation of the joystick, is represented in the hand support and below the joystick 16. This switch 14 is connected to a field generator activator unit 10 as indicated with a dashed line 12, which is also disposed hidden behind the plate 28 and therefore has been drawn in dashed manner. According to the activation situation or access authorization, the field generator activator unit 10 can control the switch 14 through the line 12 and thereby switch the joystick 16 operable or inoperable.

The arrangement for the unit 10 depends on the respective configuration of the passenger lift system and advantageously can be effected such that the energy supply of the drive 18 can also be used. Of course, an own, in particular rechargeable supply with energy, for example by a battery or an accumulator, can also be used. Further, it is of advantage if the components connected by the line 12, thus in the present case the switch 14 and the unit 10, are not located on mutually movable parts, in order to configure a signal transmission simple. Of course, the other case can also be solved, for example with wireless signal transmission or with the aid of sliding contacts.

Generally, it is true that the activator 10 is to be integrated in the environment of the transport unit or passenger supporting unit such that it is securely accommodated on the one hand and well capable of wiring on the other hand.

In addition, it is not absolutely required to switch the joystick 16. For example, the seat 20 could be switched (activated) if it is configured as a rotary seat and allows the movement of the stair lift only in a certain rotary position.

In its property as a field generator, the combined field generator activator unit 10 generates a radio field 50 surrounding the seat 20 and having a limited range of action. In the present case, the range of action should be about 2 m-3 m. With this radio field 50, a controller 70 tuned to it is associated, which is represented within the field 50, while the same unit is again drawn outside of the field as 71′ for the later explanation of an additional function.

The configuration of the radio activation is such that in case the unit 70 moves into the effective field 50, the presence of the field 50 is determined in the unit. The technology used for this is known and is not described here in more detail. If the unit 70 determines that it is in the field 50, further procedure is initiated. The interaction of the field 50 with the unit 70 is illustrated by the arrow 57.

Now, a further interaction or communication becomes effective. As is illustrated by the arrow 76, the unit 70 will generate a signal 60 and communicate with the field generator activator unit 10 (arrow 71). Thereby, an activation situation is initiated, in which the activator 10 controls the switch 16 and thus allows the control of the stair lift by means of the joystick 16.

If the radio controller 70, which can for example be configured as a key fob or belt carrying unit, again exits the field 50, the activator 10 will switch the switch 14 again such that the joystick 16 is made inoperable and the control of the stair lift is no longer possible.

Here, it is to be expressly mentioned that the way through an active determination of a field presence in the radio controller is not absolutely required for the present invention. It would also be possible to configure the radio controller as a passive, e.g. excitable element, the presence of which can be determined by the field generator activator unit, if it enters the excitation field. This is comparable to the use of RFID transponders in department store/anti-theft systems.

Finally, it is pointed out that the radio controller 70 can also be used itself as an active controller, if a preferred embodiment of the invention is implemented. The corresponding radio controller 70′ is illustrated above in the drawing and it includes an additional switch 72 capable of sending a remote control signal. This remote control signal would act on the activator 10 such that it activates the joystick 16 with the switch 14. Such an activation can for example be switched over a certain period of time such that an outsider (for example a doorman in a public building) can temporarily activate the use of the stair lift for a person, who does not possess an own radio controller 70.

What is claimed is:

1. A passenger lift system comprising:
a passenger supporting unit, and
a drive for the passenger supporting unit, wherein an access control is associated with the drive, in particular connected upstream, in or downstream to it, wherein
a radio field generator generating a spatially activity-limited stray field around the passenger supporting unit,
a radio controller capable of being introduced into the stray field, and
an activator switching the access control in response to effective introduction of the controller into the stray field, in particular switching it ready for driving.

2. The passenger lift system according to claim 1, wherein the passenger lift system is one of the following systems:
a stair lift system with a seat or chair as a passenger supporting unit and a running rail drive associated with the seat or chair,
a platform lift system with an accessible or passable platform,
a ramp lift system,
a cabin lift system.

3. The passenger lift system according to claim 1, wherein the drive is a manual drive or a power-assisted drive, in particular an electric, a mechanic, a hydraulic or a pneumatic drive or a mixed form of these drives, wherein the drive element disposed on the passenger supporting unit is a passive or active drive element.

4. The passenger lift system according to claim 1, wherein the activator directly or indirectly operates a function lock of the passenger lift system in order to switch the access control ready for driving, in particular:
on the drive itself, and/or
on the energy supply of the drive, and/or
on an operating element for movement control, e.g. a button or a joystick.

5. The passenger lift system according to claim 1, wherein the radio field generator and the activator are combined in a component.

6. The passenger lift system according to claim 1, wherein the radio field generator generates a stray field with an effective distance from the activator in the range of 0.25 m to 5 m.

7. The passenger lift system according to claim 1, wherein the radio field generator, the radio controller and/or the activator are provided with radio units, which allow communication or interaction in:
an RFID frequency band, and/or
a Bluetooth frequency band, and/or
the kHz frequency band (e.g. 125 kHz), and/or
the MHz frequency band (e.g. 433 or 866 MHz), and/or
the GHz frequency band (e.g. 2.4 GHz).

8. The passenger lift system according to claim 1, wherein the switch signals for the access control are encrypted with a high-security code, in particular with a 128 bit to 1024 bit encryption.

9. The passenger lift system according to claim 1, wherein the radio controller has at least one additional switch for remote control or remote triggering of the access authorization control supported by the access control, and further wherein the additional switch is formed for sending an operating signal by a transmitter on the controller.

10. The passenger lift system according to claim 9 wherein the range of the transmitter on the controller is greater than the effective dimension of the stray field, in particular relates to at least 1.5 times, 2 times or 3 times this dimension, especially is in a range of 3 to 100 m.

11. The passenger lift system according to claim 1, wherein the switch signals for the access control effect specific, individual access authorizations.

12. The passenger lift system according to claim 1, further having:
an access authorization control system regulating the authorization for use of said passenger lift system, wherein one or more radio controllers is or are associated with one or more passenger lift systems for switching the access control.

13. The passenger lift system according to claim 12 wherein the access authorization control system has one or more radio controllers associated with one or more passenger lift systems are fixedly tuned to the switching of the passenger lift system or the passenger lift systems by factory, in particular with respect to the radio frequency and/or the switch signal identity or encryption.

14. The passenger lift system according to claim 12 wherein the access authorization control system radio controller(s) are associated with one or more passenger lift systems and are programmable or otherwise variably tunable to the switching of the passenger lift system or the passenger lift systems, in particular with respect to the radio frequency and/or the switch signal identity or encryption.

15. The passenger lift system according to claim 14 wherein said access authorization control system according radio controller(s) are programmable and tunable to the switching of the passenger lift system or the passenger lift systems by supra-local data transmission, in particular via the Internet, especially for the activation of an access authorization for a certain category of persons provided with programmable radio controllers, in particular for passenger lift systems in public buildings.
